(19) United States
(12) Patent Application Publication
(10) Pub. No.: US 2013/0243237 A1
(43) Pub. Date: Sep. 19, 2013

(54) ELECTRONIC DEVICE WITH ANTI-RESONANCE STRUCTURE

(71) Applicants: Hong Fu Jin Precision Industry (ShenZhen) Co., Ltd., (US); HON HAI PRECISION INDUSTRY CO., LTD., New Taipei (TW)

(72) Inventors: GUAN-DONG ZHAO, Shenzhen (CN); HE-LI WANG, Shenzhen (CN)

(73) Assignees: HON HAI PRECISION INDUSTRY CO., LTD., New Taipei (TW); HONG FU JIN PRECISION INDUSTRY (ShenZhen) CO., LTD., Shenzhen (CN)

(21) Appl. No.: 13/757,859

(22) Filed: Feb. 4, 2013

(30) Foreign Application Priority Data
Mar. 16, 2012 (CN) 201210069301.0

(51) Int. Cl. H04R 1/00

(52) U.S. Cl. CPC H04R 1/00
USPC 381/386

(57) ABSTRACT

An electronic device includes a front cover, at least one speaker fixed to the front cover, a rear cover coupled to the front cover, a display panel fixed between the front cover and the rear cover, and an anti-resonance structure. The anti-resonance structure includes a number of legs, a support, and a rib protruding from the support. Each leg includes a first end protruding from the rear cover, and an opposite, second end. The support is connected to the second ends of the legs. The rib abuts against the display panel, and is configured to absorb vibration of the display panel transmitted from the at least one speaker.

### BACKGROUND

1. Technical Field

The present disclosure relates to an electronic device with an anti-resonance structure.

2. Description of Related Art

Many electronic devices, digital video disc (DVD) players, for example, include one or more speakers. The electronic devices usually include a housing, a middle frame defining a cavity, and a speaker fixed to the middle frame and positioned corresponding to the cavity. An anterior sound chamber is formed between the speaker and the housing, and a rear sound chamber is formed between the speaker and the middle frame. A foam is usually affixed between the housing and the middle frame to absorb the resonance of the speaker, thus to improve the sound effect. The affixing of the foam is usually conducted manually, which is not efficient.

Therefore, what is needed is an electronic device with an anti-resonance structure to overcome the limitations described above.

### BRIEF DESCRIPTION OF THE DRAWINGS

The components in the drawings are not necessarily drawn to scale, the emphasis instead being placed upon clearly illustrating the principles of this disclosure. Moreover, in the drawings, like reference numerals designate corresponding parts throughout the several views.

FIG. 1 is an isometric view of an exemplary embodiment of an electronic device.

FIG. 2 is an exploded view of the electronic device of FIG. 1.

FIG. 3 is similar to FIG. 2, but viewed from another perspective.

FIG. 4 is a partial, enlarged view of the electronic device of FIG. 1, showing an anti-resonance structure of the electronic device.

FIG. 5 is a cross-sectional view of the electronic device of FIG. 1, taking along line V-V.

### DETAILED DESCRIPTION

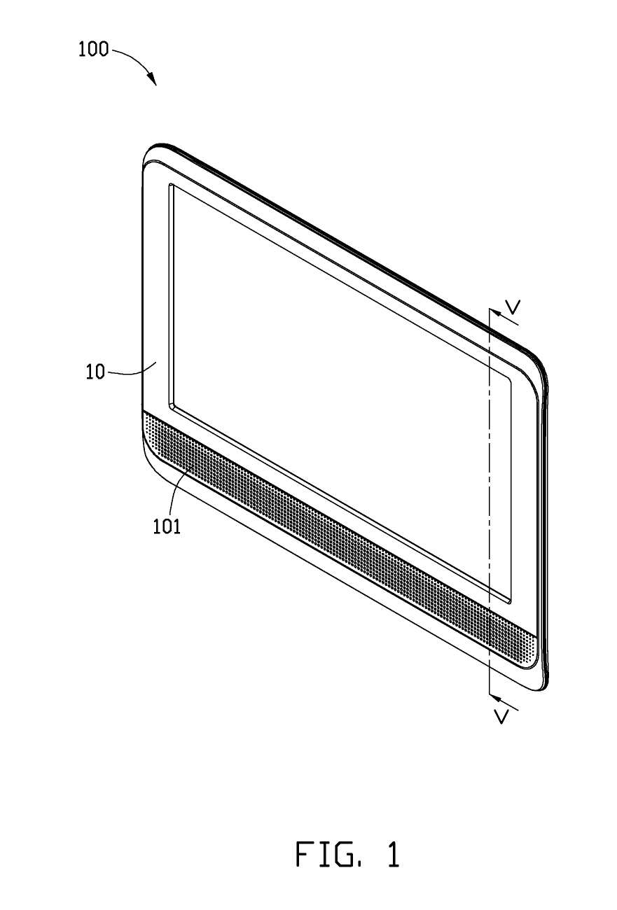

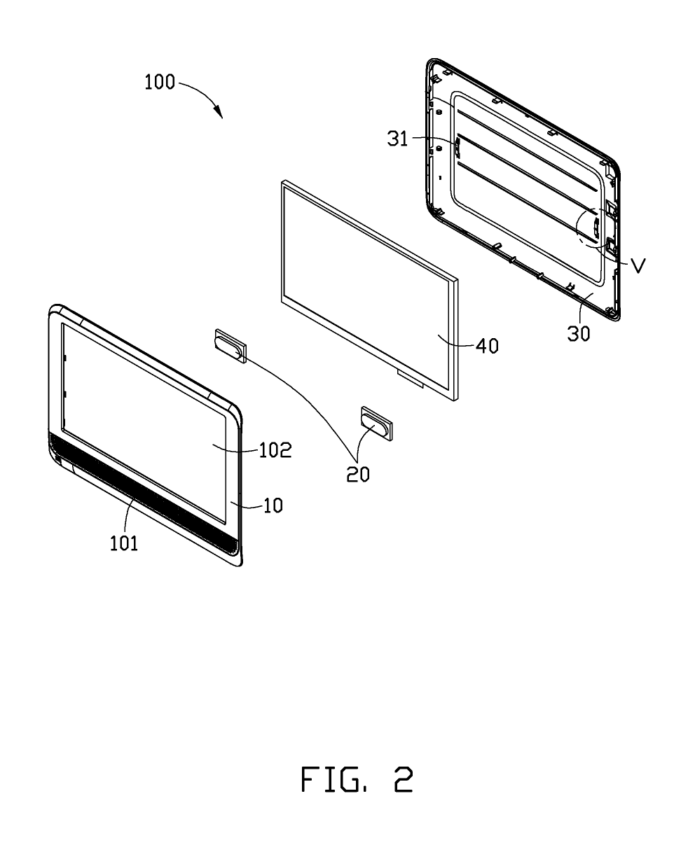

FIGS. 1 and 2 show an exemplary electronic device 100 of the disclosure. The electronic device 100 includes an front cover 10, at least one speaker 20, a rear cover 20 coupled to the front cover 10, and a liquid crystal display (LCD) panel 40 fixed between the front cover 10 and the rear cover 20. The front cover 10 defines a number of sound emitting holes 101, a through opening 102, and at least one receiving chamber 103 in an inner side. The speaker 20 is received in the receiving chamber 103. The LCD panel 40 is visible through the through opening 102, and the sound from the speaker 20 is emitted through the sound emitting holes 101. In the embodiment, the electronic device 100 is a DVD player. The number of the speaker 20 is equal to the number of the receiving chamber 103 and both are two. In other embodiments, the electronic device 100 also can be a mobile phone, a tablet computer, a music player, or other electronic devices with speakers.

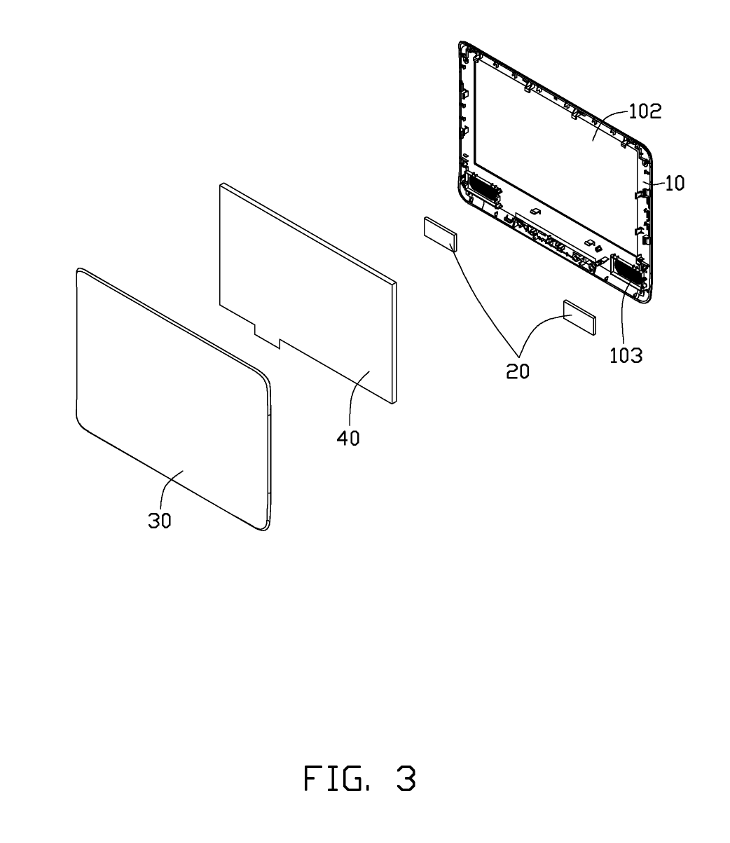

FIGS. 2-4 show that two anti-resonance structures 31 protrude from the inner surface of the rear cover 30. The anti-resonance structures 31 prevent the LCD panel 40 from being damaged by the resonance of the speakers 20.

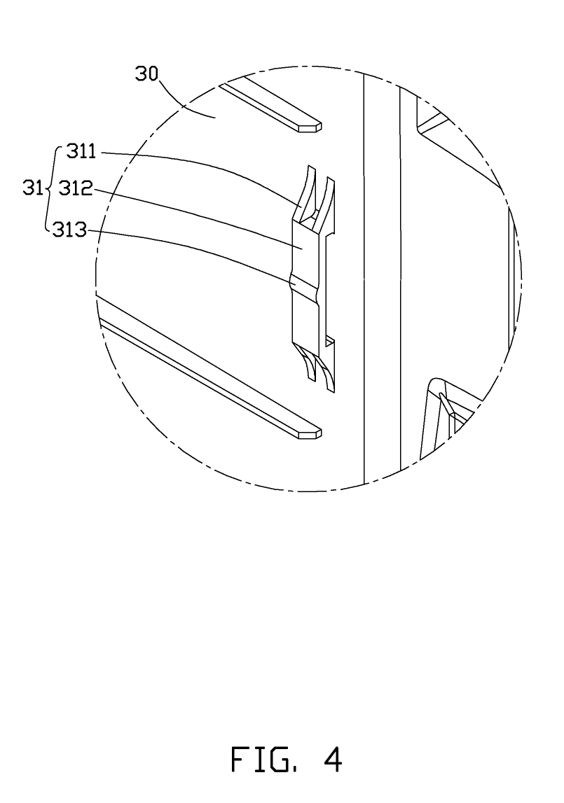

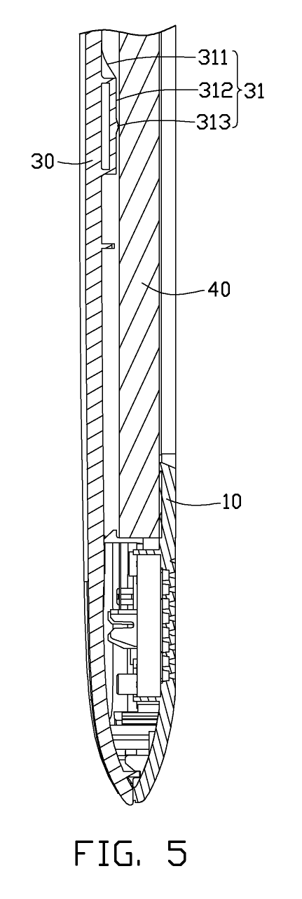

FIGS. 4 and 5 show that each anti-resonance structure 31 includes a number of legs 311 and a support 312. One end of each leg 311 protrudes from the inner surface of the rear cover 30, and the other, opposite end of the leg 311 is connected to one distal end of the support 312. The support 312 is approximately long strip-shaped. A rib 313 protrudes from the middle portion of the support 312, and resists against the LCD panel 40 to absorb the vibration transmitted from the speakers 20. In the embodiment, the rear cover 30 and the anti-resonance structures 31 are made of plastic materials having sound deformation characteristics.

In the embodiment, the anti-resonance structure 31 includes two pairs of legs 311, and one pair of legs 311 is connected to one distal end of the support 312, and the other pair of legs 311 is connected to other distal end of the support 312. The rear cover 30 and the anti-resonance structure 31 are integrally formed. The rib 313 is a ridge extending along the widthwise direction of the support 312. In an alternative embodiment, the number of the legs 311 can be varied according to need. The rear cover 30 and the anti-resonance structures 31 can be made of elastic materials, such as rubber.

Since the anti-resonance structure 31 on the rear cover 30 has sound deformation characteristics, and has a rib 313 resisting against the LCD panel 40 to absorb the vibration of the LCD panel 40 transmitted from the speakers 20. Thus effectively preventing the LCD panel 40 from being damaged by the resonance of the speakers 20, and improving the sound effect output by the electronic device 100. Compared to affixing the foam in the conventional electronic devices, the assembly is simplified for the rear cover 30 and the anti-resonance structures 31 are integrally formed.

Although the present disclosure has been specifically described on the basis of the embodiments thereof, the disclosure is not to be construed as being limited thereto. Various changes or modifications may be made to the embodiments without departing from the scope and spirit of the disclosure.

What is claimed is:

1. An electronic device comprising:
a front cover;
at least one speaker fixed to the front cover;
a rear cover coupled to the front cover;
a display panel fixed between the front cover and the rear cover; and
an anti-resonance structure, comprising:
a plurality of legs, each leg comprising a first end formed on the rear cover, and an opposite, second end;
a support connected to the second ends of the legs; and
a rib protruding from the support and abutting against the display panel, and being configured to absorb vibration of the display panel caused by the at least one speaker.

2. The electronic device as described in claim 1, wherein the rear cover and the anti-resonance structure are integrally formed, and are made of plastic material.

3. The electronic device as described in claim 1, wherein the rear cover and the anti-resonance structure are integrally formed, and are made of elastic material.

4. The electronic device as described in claim 1, wherein the support is strip-shaped and substantially parallel to the rear cover.

5. The electronic device as described in claim 1, wherein the rib is a ridge extending along a widthwise direction of the support.

6. The electronic device as described in claim 5, wherein the rib is positioned at a center portion of the support.

7. The electronic device as described in claim 1, wherein the rib is positioned at a center portion of the support.
